(19) United States
(12) Patent Application Publication
(10) Pub. No.: US 2022/0346405 A1
(43) Pub. Date: Nov. 3, 2022

(54) NON-DAIRY SOFT SERVE COMPOSITION

(71) Applicant: Oatly AB, Malmo (SE)

(72) Inventors: Joakim Bjunö, Malmo (SE); Todd Stanley, Malmo (SE); Julie House, Malmo (SE); Karin Petersson, Malmo (SE); Sofia Ehlde, Malmo (SE)

(21) Appl. No.: 17/244,787

(22) Filed: Apr. 29, 2021

(51) Int. Cl. A23G 9/42; A23G 9/32; A23G 9/34; A23G 9/38

(52) U.S. Cl. CPC A23G 9/42; A23G 9/327; A23G 9/34; A23G 9/38; A23V 2002/00

(57) ABSTRACT

A non-dairy soft serve composition contains an oat-derived material, which includes dry matter in an amount of 1 to 15% by weight of the composition, non-hydrogenated vegetable fat present in an amount of 3 to 15% by weight of the composition, sugars present in an amount of 10 to 35% by weight of the composition, water, and vegetable protein. The vegetable fat contains less than 20% saturated fats.

### FIELD OF THE INVENTION

The invention relates to a non-dairy soft serve composition and a process for manufacturing of a non-dairy soft serve composition.

### BACKGROUND OF THE INVENTION

Soft serve is a soft kind of ice cream, which contains air, introduced at the time of freezing. The air content called overrun, can vary from 0 to 60 percent of the total volume of the finished product. The amount of air alters the taste of the finished product. Product with low quantities of air has a heavy, icy taste and appears more yellow. Ice cream with higher air content tastes creamier, smoother, and lighter and appears whiter. The optimum quantity of air is determined by other ingredients, if any, and individual taste.

Some forms of soft serve, like many other processed foods, have palm oil.

All ice cream must be frozen quickly to avoid crystal growth. With soft serve, this is accomplished by a special machine at the point of sale. Typically, pre-mixed product is introduced to a storage chamber of the machine where it is kept at 3° C. (37° F.). When the product is drawn from the draw valve, fresh mix combined with the targeted quantity of air is introduced to the freezing chamber. It may then be churned, frozen and stored until required.

A demand for dairy substitute products is increasing and has been increasing over several years, due to a desire from consumers to exclude or reduce the amount of animal and dairy products from their diet.

There is a further demand and need for dairy substitute products taking sustainability into account as well as health aspects, fueled by an interest in sustainability, vegetarianism, veganism as well as for improved health.

Non-dairy ice creams substitutes are available. WO2017/001265 discloses a frozen confection comprising 6-10 wt % saturated oil, 0.5-4 wt % vegetable protein, 1-8 wt % nut solids, 10-30 wt % sugar solids, 0.1-1 wt % emulsifier, and 0.1-1 wt % stabilizer.

There is a further interest and demand to reduce or eliminate use of palm oil in food products. It is common for dairy replacement products, to contain fat from palm oil and/or hydrogenated fat to compensate for the high fraction of saturated fat in animal fat.

There is, thus, a need for non-dairy soft serve composition with improved properties, such as organoleptic properties and/or based on ingredients taking sustainability and health aspects into account.

### SUMMARY OF THE INVENTION

One object of the invention is to alleviate, at least in part, drawbacks of the prior art. One object of the invention is to provide a non-dairy soft serve composition without hardened fat. One object of the invention is to provide an oat-based soft serve composition.

According to one aspect of the invention, there is provided a non-dairy soft serve composition, comprising: an oat-derived material comprising dry matter in an amount of 1 to 15% by weight of the composition; non-hydrogenated vegetable fat present in an amount of 3 to 15% by weight of the composition; sugars present in an amount of 10 to 35% by weight of the composition; water; and vegetable protein, wherein the vegetable fat contains less than 20% saturated fat. Non-dairy ice creams of prior art often use hardened (hydrogenated) vegetable fat or vegetable fat having a high fraction of saturated fat to obtain acceptable texture and stability. The composition described herein, on the other hand and unexpectedly, has good emulsification properties and provides desirable organoleptic properties is palatable without the need of hardened fats or a vegetable fat having a high fraction of saturated fats.

The vegetable protein may be selected from pea protein, potato protein, and oat protein other than oat protein from the oat-derived material.

The oat-derived material may be a liquid oat base or oat syrup.

The oat-derived material may have been obtained from treatment of oats comprising treatment with amylase.

The water may be present in an amount of 40 to 70% by weight of the composition.

The sugars may comprise glucose and/or sucrose.

The soft serve composition may further comprise mono- and/or di-glycerides.

The soft serve composition may further comprise one or more of guar gum, locust bean gum and gellan gum.

The non-hydrogenated vegetable fat may comprise at least 50% rapeseed oil.

The vegetable fat may comprise at least 75% rapeseed oil by weight of the vegetable fat.

The vegetable fat may comprise at least 90% by weight of non-hydrogenated rapeseed oil and be present in an amount of 4 to 10% by weight of the composition.

The vegetable protein may comprise at least 90% of pea protein.

According to another aspect of the invention, there is provided a process for manufacturing of a non-dairy soft serve composition according to the one aspect, comprising the steps of
(a) providing an aqueous liquid comprising an oat-derived material comprising dry matter in an amount of 1% to 15% by weight of the composition;
(b) providing vegetable protein;
(c) providing sugars;
(d) adding said sugars and said vegetable protein to the aqueous liquid;
(e) providing a non-hydrogenated vegetable fat;
(f) adding said vegetable fat to the mixture resulting from d); and
(g) subjecting the composition to heat treatment and homogenization followed by cooling,
wherein the non-hydrogenated vegetable fat is present in an amount of 3 to 15% by weight of the composition.

The cooling may be conducted to below 10° C., such as below 9° C., such as below 8° C.

### DETAILED DESCRIPTION OF THE INVENTION

The present invention will now be described more fully hereinafter. This invention may, however, be embodied in many different forms and should not be construed as limited to the embodiments set forth herein; rather, these embodiments are provided for thoroughness and completeness, and fully convey the scope of the invention to the skilled person. Although individual features may be included in different embodiments, these may possibly be combined in other ways, and the inclusion in different embodiments does not imply that a combination of features is not feasible. In addition, singular references do not exclude a plurality. In the context of the present invention, the terms “a”, “an” does not preclude a plurality.

The present inventive concepts are, at least in part, based on unexpected realizations including that a non-dairy soft serve composition, as defined by the appended claims and examples and embodiments described herein, i.e. a non-dairy soft serve composition comprising an oat-derived material, non-hydrogenated vegetable fat, sugars present, water, and vegetable protein, may be provided having beneficial or desirable properties.

The presence of the oat-derived material in the composition with resulting benefits have been made possible. Thus, soft serve compositions according to the present inventive concept, are achievable with desirable texture and organoleptic properties while not having to use hardened fat or high levels of saturated fats. It has further been made possible to combine oat-derived material with its health benefits and other ingredients, which together form a desirable non-dairy soft serve composition, which composition further may be selected to be environmentally sustainable.

Non-dairy, as used herein, is intended to describe a composition essentially free from dairy components. In addition to being described as a non-dairy soft serve composition, the composition may be described as a plant-based, a vegetable, a vegan, and/or a vegetarian non-dairy soft serve composition. The non-dairy soft serve composition may be totally free from animal ingredients. However, the non-dairy soft serve composition may contain additives derived from animal sources, and still be according to embodiments described herein.

Vegetable protein as use herein refers to a vegetable protein obtained from a plant source, such as e.g. peas. The vegetable protein may be provided as a fraction being rich in protein from the plant source. Although the protein fraction may essentially or entirely consist of proteins from the plant source, thus a highly or entirely purified vegetable protein source is not excluded, it may also comprise other components from that plant source in addition to the protein, from that plant source. For example, protein concentrate and protein isolate may be used for providing the vegetable protein, which shall be considered to comprise at least 50%, such as at least 56% of protein by weight of the vegetable protein fraction, concentrate or isolate, the remainder being components other than the protein. Such additional vegetable protein fractions may typically be more readily available as compared to a pure source of protein.

According to one aspect of the invention, there is provided a non-dairy soft serve composition, comprising:
an oat-derived material comprising dry matter in an amount of 1 to 15% by weight of the composition;
non-hydrogenated vegetable fat present in an amount of 3 to 15% by weight of the composition;
sugars present in an amount of 10 to 35% by weight of the composition;
water; and
vegetable protein,
wherein the vegetable fat contains less than 20% saturated fat.
Non-dairy ice creams of the prior art often use hardened (hydrogenated vegetable fat) or use fat sources naturally rich in saturated fat, such as coconut fat, in order to get the right texture and stability. The composition according to the invention, on the other has good emulsification properties and is palatable without the need of hardened fats.

The non-dairy soft serve composition may be seen as a non-dairy, vegan analogue of soft serve ice cream. The soft serve composition is typically used or intended to be used in a soft serve machine which introduces air at the time of freezing, called overrun. The composition may be run with 30 to 70 percent overrun.

Non-dairy ice cream of prior art often uses hardened (hydrogenated) vegetable fat to obtain acceptable texture and stability. The composition described herein, on the other hand and unexpectedly has good emulsification properties and provides desirable organoleptic properties and is palatable without the need of hardened fats and without the need of high amounts of saturated fat.

The oat-derived material may comprise dry matter in an amount of 4 to 10% by weight of the composition, such as 5 to 9% by weight of the composition or 6 to 9% by weight of the composition, such as 6.0 to 8.0% by weight of the composition.

Typically, the total solids fraction in the composition is 30 to 45% by weight, such as 35 to 40% by weight, such as 36 to 39% by weight. The density of the composition may be 1 to 1.3 kg per liter, such as 1.05 to 1.2 kg per liter.

The composition may be in form of an emulsion comprising a fat phase and an aqueous phase.

The vegetable protein may be for example pea protein, potato protein or oat protein other than any oat protein from the oat-derived material. Further, the oat-derived material naturally may contain protein, such as 0.5 to 2% by weight, but additional vegetable protein, such as pea protein, is comprised by the composition such that 0.5 to 5% by weight of the composition is protein. The total amount of protein, including oat protein from the oat derived material and the vegetable protein, may be 0.5 to 5% by weight of the composition, such as 0.7 to 2% by weight of the composition.

The vegetable protein (in addition to the protein in the oat derived material) may be pea protein. Typically, the vegetable protein, such as pea protein is present in an amount of 0.1 to 2% by weight of the composition, such as 0.2 to 1% by weight of the composition, such as 0.3 to 0.8% by weight of the composition.

The vegetable protein, such as pea protein, used in the manufacturing of the soft serve composition typically is provided as an isolate containing at least 80% protein.

The oat-derived material may be a liquid oat base, such as an oat drink or oat milk, or oat syrup.

The oat-derived material, such as a liquid sometimes referred to as an oat drink or oat milk, may have been obtained from treatment of oats comprising treatment with amylase. The oat derived material may be described as obtained from treatment of oats, comprising degradation or break-down of starch from the oats, with suitable enzymes such as amylase. For example, α- and/or β-amylase may be used. Thereby, the oat derived material may comprise one, more or all of monosaccharides, disaccharides, for example, maltose, oligosaccharides, and/or fiber, for example β-glucans. The oat derived material may further comprise proteins and fat from the oats. All or part of unreacted or partly reacted starch and fibers from the oats may be removed or reduced in content in the treatment of the oats or prior to the addition of the oat-base to the soft serve composition.

The oat derived material may be provided in dry form during manufacturing of the soft serve composition. Further, the oat derived material may be provided as a liquid, or aqueous oat derived material during manufacturing of the soft serve composition. Thus, the oat derived material may be a liquid oat-derived material. The oat-derived material may be an oat drink, for example a liquid product sometimes referred to as an oat milk. For the purpose of improving understanding, the soft serve composition may be obtained using a liquid or aqueous oat derived material during manufacturing comprising, for example, 1-20% by weight of dry matter, such as 10-16% by weight.

An oat base containing higher amount of solids, such as around 20% may be diluted with water to a target of lower total-solids. Such a diluted oat base may serve as a liquid oat-derived material.

Furthermore, said oat derived material, e.g. in form of a liquid oat drink, may comprise 5-15%, by dry weight, of protein, e.g. 6-14%, 7-13%, 6-12%, by dry weight of protein, and 3-10%, by dry weight, of fat, e.g. 4-9%, 5-8%, by dry weight, of fat. The oat derived material may also comprise carbohydrates and/or starch. Thus, in addition to e.g. the vegetable protein and sugar comprised by the composition oat protein and oat derived sugars may be added the soft serve composition from the oat derived material.

The oat derived material may be provided in an amount of 1-20% dry matter by weight, such as 3-15% dry matter by weight, or 5-10% dry matter, by weight, of the soft serve composition which allows for introduction of beneficial properties to the soft serve composition. The oat derived material may provide for example flavor, color, texture, and structure to the soft serve, as well as, for example, providing a source of proteins, vegetable fat and fibers. For example, the oat derived material may provide 6-glucans to soft serve composition, which in combination with other ingredients of the soft serve composition may provide health-beneficial properties.

It shall been realized and appreciated that the oat-derived material, such as in form of liquid oat base, oat drink, oat syrup, or in dry form, may be provided during manufacturing of the composition more or less or without dilution with water or aqueous liquid and with or without further addition of water, as long as the total amount of water in the composition is suitable for the composition or in accordance with embodiments discussed herein.

The non-hydrogenated vegetable fat may contain less than 15% by weight of saturated fat, for example less than 10% by weight of saturated fat. The non-hydrogenated vegetable fat may contain 3 to 15% by weight of saturated fat, such as 3 to 10% by weight of saturated fat. The composition according to embodiments, surprisingly, has desirable emulsification properties and stability when used as soft serve without the need of a high fraction of saturated fats in the composition.

The pH of the soft serve composition may be between 6 and 8, such as between 6.5 and 7.5.

The composition may further comprise a buffering agent. The buffering agent may be selected from suitable food acidity regulators. For example, the buffering agent may be selected from the group consisting of rac-lactic acid, phosphoric acid, acetic acid, adipic acid, citric acid, fumaric acid, malic acid or a suitable salt thereof, such as a sodium salt, a potassium salt, a disodium salt, a dipotassium salt, ammonium salt, or a magnesium salt thereof. Typical buffering agents include rac-lactic acid, acetic acid, adipic acid, citric acid, fumaric acid, malic acid, monosodium fumarate, potassium acetate, dipotassium phosphate, sodium citrate, potassium hydrogencarbonate, disodium fumarate, disodium malate, ammonium hydroxide, ammonium acetate, magnesium citrate, sodium lactate, and ferric ammonium citrate, for example dipotassium phosphate.

The water may be present in an amount of 40 to 70% by weight of the composition, such as 50 to 70%, such as 55 to 65% by weight of the composition. The water may be expressed as the total water of the composition, e.g. comprising water added as free water during manufacturing of the composition, and any water present with ingredients of the composition, which may be the case for example if liquid or aqueous oat base is used.

The sugars may comprise one or more of glucose or sucrose. In addition to the sugars, sugar may present in the oat derived material.

The sugars may comprise sucrose in an amount of 3 to 15% by weight of the composition, such as 5 to 12% by weight of the composition. The sucrose may be in the form of so-called liquid sucrose or sucrose syrup which is an aqueous sucrose solution. The weights indicated in this paragraph refer to the corresponding dry amount of sucrose.

The sugars may comprise dextrose in an amount of 3 to 10% by weight of the composition, such as 4 to 8% by weight of the composition. The dextrose may be in part in pure form and in part as a constituent in the glucose solids.

The sugars may comprise glucose solid in an amount of 2 to 10% by weight of the composition. The glucose solids may be a dried corn syrup containing, glucose, maltose, maltotriose and higher saccharides.

The composition may further comprise emulsifiers, such as mono- and/or di-glycerides, such as monoglycerides. Mono- and di-glycerides may function to displace protein and promote partial coalescence. Typically, the mono- and diglycerides are present in an amount of 0.05% to 0.5% by weight of the composition.

The composition may further comprise stabilizers, such as one or more of guar gum, locust bean gum and gellan gum, such as locust bean gum and gellan gum, such as guar gum and locust bean gum, such as all of guar gum, locust bean gum and gellan gum. Typically, the amount of gellan gum, guar gum and locust bean gum is in total 0.05% to 0.5% by weight of the composition.

The composition may further comprise other ingredients and additives, for example, the composition may comprise one or more of salt, coloring agents, flavorings, vitamins etc. Flavorings may include vanilla, chocolate (cocoa), strawberry, raspberry, or blueberry, such as vanilla and/or cocoa.

The salt (NaCl) may be plain table salt or sea salt. The amount of salt may be 0.05% to 1%, such as 0.06 to 0.5% by weight of the composition.

The non-hydrogenated vegetable fat may comprise at least 50% rapeseed oil, such as at least 75% rapeseed oil by weight of the vegetable fat. For example, the non-hydrogenated vegetable fat may comprise at least 95% rapeseed oil by weight of the vegetable fat. Rapeseed oil, which sometimes is referred to as canola oil, herein refers to non-hydrogenated rapeseed oil, which has around 5 to 10% by weight of saturated fats. It has been realized that non-dairy soft serve composition containing mostly rapeseed oil as the vegetable fat has excellent organoleptic properties and mouthfeel.

The vegetable fat may comprise at least 90% by weight of non-hydrogenated rapeseed oil and be present in an amount of 4 to 10% by weight of the composition.

The vegetable fat may be rapeseed oil.

Rapeseed oil may provide the composition with a fat having suitable levels of non-hydrogenated vegetable fat and function to provide the composition with desirable properties.

The vegetable protein may comprise at least 90% of pea protein. The pea protein may be provided in form of pea protein isolate or concentrate.

According to another aspect of the invention, there is provided a process for manufacturing of the non-dairy soft serve composition, comprising the steps of
(a) providing an aqueous liquid comprising an oat-derived material comprising dry matter in an amount of 1% to 15% by weight of the composition;
(b) providing vegetable protein;
(c) providing sugars;
(d) adding said sugars and said vegetable protein to the aqueous liquid;
(e) providing a non-hydrogenated vegetable fat;
(f) adding said vegetable fat to the mixture resulting from d); and
(g) subjecting the composition to heat treatment and homogenization followed by cooling,

wherein the non-hydrogenated vegetable fat is present in an amount of 3 to 15% by weight of the composition.

The cooling may be done to below 10° C., such as below 9° C., such as to below 8° C.

Features from the composition aspect of the invention may be used in the process aspect of the invention, and vice versa.

### Examples

Examples of manufacturing of a non-dairy soft serve composition according to embodiments will now be discussed in an attempt to improve an understanding of present inventive concepts.

In this example, the oat-derived material was a liquid oat base (oat derived material). The liquid oat base for this example may be obtained from treatment of oats comprising treatment with amylase, for example, as has been described in patent No. EP 1 383 396 B1. The liquid oat base is mixed with water to produce an aqueous phase comprising oat-derived material in a batch tank until homogenous. The target of total solids is 12% (% TS). Some water is withheld from the dilution to account for any water pushes, water in the lines, etc. to ensure the final % TS being within specification. The aqueous phase comprising oat-derived material is recirculated between the batch tank and a liquefier.

Liquid sucrose is added to the batch tank. To the liquefier, the following ingredients are added in order:
Pea protein
Alkalized cocoa powder (if chocolate flavored composition).
Dextrose
Glucose Syrup Solids
Mono- and diglycerides
Sea Salt
Dipotassium Phosphate
Stabilizer Blend consisting of guar gum, locust bean gum and gellan gum Rapeseed oil is added to the liquefier followed by vanilla flavor. The resulting mixture is mixed until product is homogenous, minimum 5 minutes.

The product is tested, the % TS is measured and adjusted to target solids with held back water, if needed. The mixture is subjected to heat treatment—UHT 142° C. for 2 s, Min 138° C. and homogenized at a total pressure of 2500 psi (2000 psi in the first stage, 500 psi in the second stage). The heat-treated mixture is cooled to <7° C. (45° F.). The product is filled into containers. The proportions of the ingredients are according to the recipes in Tables 1 and 2.

TABLE 1

| Recipe: | Vanilla 1 | Chocolate 1 |
|---|---|---|
| Ingredient | Amounts (% by weight) | |
| Oat Base | 45 | 45 |
| Water | 17.5 | 17.5 |
| Liquid Sucrose | 12.9 | 13.1 |
| Pea Protein | 0.5 | 0.5 |
| Alkalized Cocoa Powder | 0.0 | 2.2 |
| Dextrose | 7.0 | 6.0 |
| Glucose Syrup Solids | 9.2 | 9.0 |
| Mono- and diglycerides | 0.1 | 0.1 |
| Sea Salt | 0.18 | 0.18 |
| Dipotassium Phosphate | 0.02 | 0.02 |
| Stabilizer Blend | 0.1 | 0.1 |
| (Guar, Locust, Gellan Gums) | | |
| Rapeseed Oil | 7.0 | 6.0 |
| Vanilla Flavor | 0.5 | 0.3 |
| Tot | 100 | 100 |

TABLE 2

| Recipe: | Vanilla 2 | Chocolate 2 |
|---|---|---|
| Ingredient | Amounts (% by weight) | |
| Oat Base | 52.5 | 52.5 |
| Water | 17.5 | 17.5 |
| Liquid Sucrose | 11.0 | 11.0 |
| Pea Protein | 0.5 | 0.3 |
| Alkalized Cocoa Powder | 0 | 3 |
| Dextrose | 7.2 | 6 |
| Glucose Syrup Solids | 4.9 | 3.3 |
| Mono- and diglycerides | 0.1 | 0.1 |
| Sea Salt | 0.1 | 0.1 |
| Dipotassium Phosphate | 0.1 | 0.1 |
| Stabilizer Blend | 0.1 | 0.1 |
| (Guar, Locust, Gellan Gums) | | |
| Rapeseed Oil | 5.5 | 5.5 |
| Vanilla Flavor | 0.5 | 0.5 |
| Tot | 100 | 100 |

The target total solids for the composition (product) is around 37.7% for vanilla and around 38% for chocolate.

The fraction of saturated fat in the rapeseed oil is within 3 to 10%.

Results: The non dairy soft serve compositions showed good emulsification properties, stability and had good organoleptic properties and mouthfeel.

What is claimed is:

1. A non-dairy soft serve composition, comprising:
an oat-derived material comprising dry matter in an amount of 1 to 15% by weight of the composition;
non-hydrogenated vegetable fat present in an amount of 3 to 15% by weight of the composition;
sugars present in an amount of 10 to 35% by weight of the composition;
water; and
vegetable protein,
wherein the vegetable fat contains less than 20% saturated fat.

2. The soft serve composition according to claim 1, wherein the vegetable protein is selected from pea protein, potato protein, and oat protein other than oat protein from the oat-derived material.

3. The soft serve composition according to claim 1, wherein the oat-derived material is a liquid oat base or oat syrup.

4. The soft serve composition according to claim 1, wherein the oat-derived material has been obtained from treatment of oats comprising treatment with amylase.

5. The soft serve composition according to claim 1, wherein the water is present in an amount of 40 to 70% by weight of the composition.

6. The soft serve composition according to claim 1, wherein the sugars comprises glucose and/or sucrose.

7. The soft serve composition according to claim 1, further comprising mono- and/or di-glycerides.

8. The soft serve composition according to claim 1, wherein the composition further comprises one or more of guar gum, locust bean gum and gellan gum.

9. The soft serve composition according to claim 1, wherein the non-hydrogenated vegetable fat comprises at least 50% rapeseed oil.

10. The soft serve composition according to claim 1, wherein the vegetable fat comprises at least 75% rapeseed oil by weight of the vegetable fat.

11. The soft serve composition according to claim 1, wherein
the vegetable fat comprises at least 90% by weight of non-hydrogenated rapeseed oil and is present in an amount of 4 to 10% by weight of the composition.

12. The soft serve composition according to claim 1, wherein
the vegetable protein comprises at least 90% of pea protein.

13. A process for manufacturing of a non-dairy soft serve composition according to claim 1, comprising the steps of
(a) providing an aqueous liquid comprising an oat-derived material comprising dry matter in an amount of 1% to 15% by weight of the composition;
(b) providing vegetable protein;
(c) providing sugars;
(d) adding said sugars and said vegetable protein to the aqueous liquid;
(e) providing a non-hydrogenated vegetable fat;
(f) adding said vegetable fat to the mixture resulting from d); and
(g) subjecting the composition to heat treatment and homogenization followed by cooling,
wherein the non-hydrogenated vegetable fat is present in an amount of 3 to 15% by weight of the composition.

14. The process according to claim 1, wherein said cooling is done to below 10° C.
